(19) United States
(12) Patent Application Publication
(10) Pub. No.: US 2013/0340656 A1
(43) Pub. Date: Dec. 26, 2013

(54) Internetworked Secure Digital Safe

(71) Applicant: Rajiv Rainier, San Diego, CA (US)

(72) Inventor: Rajiv Rainier, San Diego, CA (US)

(21) Appl. No.: 13/527,896

(22) Filed: Jun. 20, 2012

(51) Int. Cl. E05G 1/10; G06F 15/16; E05G 1/02

(52) U.S. Cl. 109/38; 109/23

(57) ABSTRACT

Systems and apparatus are provided for an internetworked secure digital safe that provides interior physical storage space, virtual online storage space, and cloud-based data collection and monitoring services. The systems and apparatus further provide for collection, storage, uploading, downloading, sharing, automating, synchronizing, encrypting, deleting and monitoring of digital data and electronic records. The cloud service interacts with user-specified third-party providers and sources, such as financial institutions, credit bureaus, identity theft monitoring services, social networks, and other web-accessible databases, to access, monitor, download and manage user information to prevent fraud. The systems and apparatus may also be programmed to generate alerts and notifications. The systems and apparatus may be accessed by a wired or wireless computer, mobile phone, tablet device, consumer electronic device, online website, software application, database or online storage site.

### BACKGROUND OF THE INVENTION

Safes are commonly used to store valuable papers and materials against theft or damage. These devices typically comprise a secure lockable box having an accessible interior space, with one face that is removable or hinged to form a door. The body of the safe and the door may be metal or plastic. More secure safes may be attached to a wall or floor in a hidden location, while less secure models can be described as portable boxes known as a lock-box or cash-box. Other variations include jewelry safes, gun safes, and bank-vaults. In some cases, these safes may be fire resistant, or protect against other environmental conditions, such as water and dust.

Hard drives and other memory devices are available for storage of electronic information. These devices are available in a variety of sizes and formats, including configurations that may be fireproof, or waterproof. Likewise, services are also available for storage of information in the cloud.

Online services are available through financial institutions and third-parties that permit a user to access and, in some cases download, account and transaction information. Such services are useful in monitoring balances, reviewing expenses and preparing budgets. Other entities provide credit monitoring, identity theft monitoring, and online reputation monitoring, and typically provide information to the user via emails, text messages and other notification in the event that monitored information is accessed or changed. Finally, software is available for scanning, organization and storage of personal financial information, such as bills, receipts, etc.

While the foregoing technology and services are useful, they suffer from several limitations, including the need to subscribe to multiple services in order to obtain a complete picture of one's information. Additionally, there is currently no system or apparatus that offers a combination of A) interior storage space for physical valuables, documents and possessions, B) virtual storage space on the internet for sensitive data and information and C) an intelligent cloud service that interacts with online financial institutions, credit bureaus, identity theft monitoring services, social networks, trusted software applications and secure databases to access and monitor a user's financial information, credit reports and scores, and online identity in order to alert the user when the user's information is compromised.

It is also difficult to organize, update and compile data from multiple sources. As a result, a user can be overwhelmed by data, and important information can be lost due to hardware and software failures, identity theft, hacking, and catastrophic events. In addition, users of existing systems and technology must spend a significant amount of time continuously monitoring, organizing, synchronizing, analyzing, maintaining and backing-up information and preventing identity theft and fraud, which often leads to non-compliance.

### SUMMARY OF THE INVENTION

The invention relates to an internetworked secure digital safe that provides interior storage space, virtual online storage space and a cloud service. The internetworked safe's interior storage space allows the user to store physical valuables, documents and possessions. The internetworked safe's online virtual storage space permits collecting, storing, uploading, downloading, sharing, automating, synchronizing, analyzing, encrypting, deleting, backing-up and monitoring digital data and electronic records. The internetworked safe's cloud service uses the Internet to connect and interact with user specified online financial institutions, credit bureaus, identity theft monitoring services, social networks, trusted software applications and secure databases to access, monitor and manage the user's financial information, credit reports and scores, and online identity, in order to prevent fraud and identity theft and alert the user when the user's financial information, online identity and credit score and rating is compromised. The internetworked safe can be accessed by a wired or wireless computer, phone, handheld device, consumer electronic device, online website, software application, database or online storage sites via wired and wireless networks, satellite networks, or internetworking technologies and protocols.

In one embodiment, the internetworked secure digital safe is located in a physical location or home, where it can be accessed by a variety of devices such as a computer, phone, handheld device, or consumer electronic device via wired and wireless networks, satellite networks, or internetworking technologies and protocols. In another embodiment, sensitive electronic information can be accessed, collected, stored, uploaded, downloaded, shared, automated, synchronized, encrypted, deleted and monitored from a location external to the internetworked secure digital safe, such as via a secure online virtual service. In a third embodiment, the system exists entirely within the internetworked secure digital safe's virtual cloud on the internet. In all three embodiments, the internetworked secure digital safe, its virtual storage space on the internet, and its cloud service can be accessed by a wired or wireless computer, phone, handheld device, or consumer electronic device, or via an online website, a software application, or an online storage service.

The system, method and apparatus can provide the user with a set of customized and pre-programmed services and options to allow the user to personalize and select how the user's physical valuables and virtual data, financial and credit information, online identity and credit scores can be accessed, backed up, synchronized, exchanged and monitored in order to safeguard the user's physical valuables, protect the user's private data and online information, monitor the user's financial information and credit rating, prevent identity theft, protect the user's online reputation and alert the user and/or the appropriate authorities when the user's physical valuables, digital data, financial information, credit rating, online identity is in danger of being compromised.

The invention can also include cameras and sensors on the secure digital safe to capture and transmit electronic video and images. Likewise, the system can be programmed to send alerts and other forms of notification to the user, or to individuals, authorities and institutions designated by the user, if certain events are detected by the system or by monitoring services that are synched to the system. For example, if and when the system is compromised, a built-in security and alarm system can automatically sound an alarm and send text, voice or video messages to the owner(s) and designated user(s), law enforcement authorities, financial institutions, credit monitoring agencies and institutions the owner(s) or designated user(s) chooses to inform. It could also be programmed to automatically erase all digital data and send a text and voice message to the owner(s) as well as law enforcement authorities and services. The system can also include a GPS feature wherein the location of the Internetworked safe can be detected or monitored and, if the safe is transferred to a different location, location details may be transmitted to entities designated by the user.

### BRIEF DESCRIPTION OF THE DRAWINGS

The above and other objects and advantages of the invention will be apparent upon consideration of the following detailed description, taken in conjunction with the accompanying figures, in which like reference characters refer to like parts throughout, and in which:

FIG. 1 is a front view of a device in accordance with an embodiment of the invention.

FIG. 2 is an illustrative schematic diagram showing the internal components of an embodiment of the invention.

FIG. 3 is a rear view of a device in accordance an embodiment of the invention.

FIG. 4 is an illustrative schematic diagram showing an embodiment of the invention.

FIG. 5 is an illustrative schematic diagram showing an embodiment of the invention.

FIG. 6 is an illustrative schematic diagram showing an embodiment of the invention.

FIG. 7 is an illustrative schematic diagram showing an embodiment of the invention.

FIG. 8 is an illustrative diagram of a graphical user interface according to an embodiment of the invention.

FIG. 9 is an illustrative schematic diagram showing an embodiment of the invention.

FIG. 10 is an illustrative block diagram of a system according to an embodiment of the invention.

### DETAILED DESCRIPTION OF THE EXEMPLARY EMBODIMENTS

The present invention is described below with reference to the illustrative diagrams in accordance with the invention. It is understood that the systems and apparatus described in each of the diagrams may be implemented by means of analog or digital hardware and computer program instructions. These computer program instructions may be provided to a processor of a general purpose computer, special purpose computer, ASIC, or other programmable data processing apparatus, such that the instructions, which execute via the processor of a computer or other programmable data processing apparatus, implements the functions/acts specified in the diagrams and text of this application.

The invention comprises four components—the physical components, the interconnection between the physical components, the interface that permits selection of the programming and access to the stored information, and the programming that runs the systems and processes.

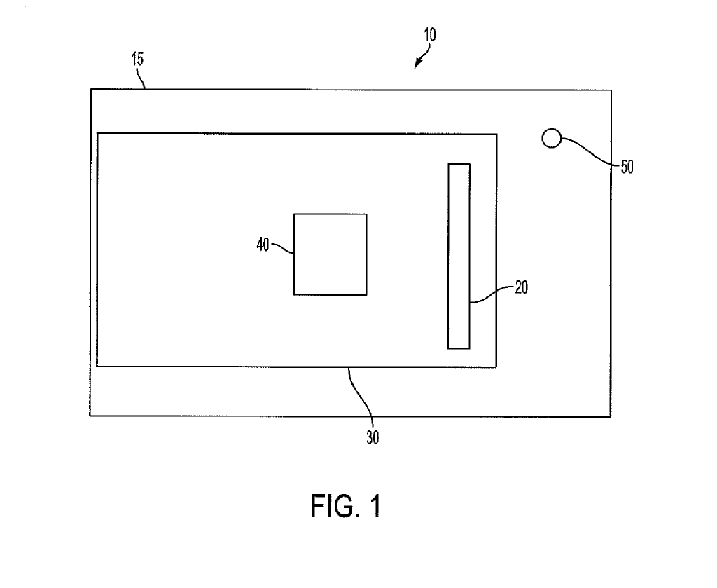

As shown in FIGS. 1-3, one embodiment employs a safe-like device 10 that employs a housing 15 having an exterior surface. The housing includes a door 30 having a handle 20 which permits access to an interior space. If storage of physical items is desired, interior storage space can be provided. The door is secured with a locking mechanism 40, which can comprise one or more of a combination or key lock, an electronic lock such as a lock attached to a digital access pad, or a biometric locking device, such as a fingerprint reader or retina scan device. In the alternative, the lock could employ facial recognition technology operating in conjunction with a camera 50 positioned on the exterior of the safe 10. The lock could also be controlled through near field communications (NFC) technology, or programmed to periodically generate a random password to control access.

The safe may include one or more cameras positioned on the exterior surface of the housing 10, programmed to monitor the safe or to capture video or still photographs on a periodic basis, such as when the safe is accessed. As described below, the camera (alone or together with an optional interior camera) permits the user to monitor persons accessing the safe, and to observe the interior of the safe through a secure communications connection. In a preferred embodiment, the safe is constructed so as to be fire proof and waterproof.

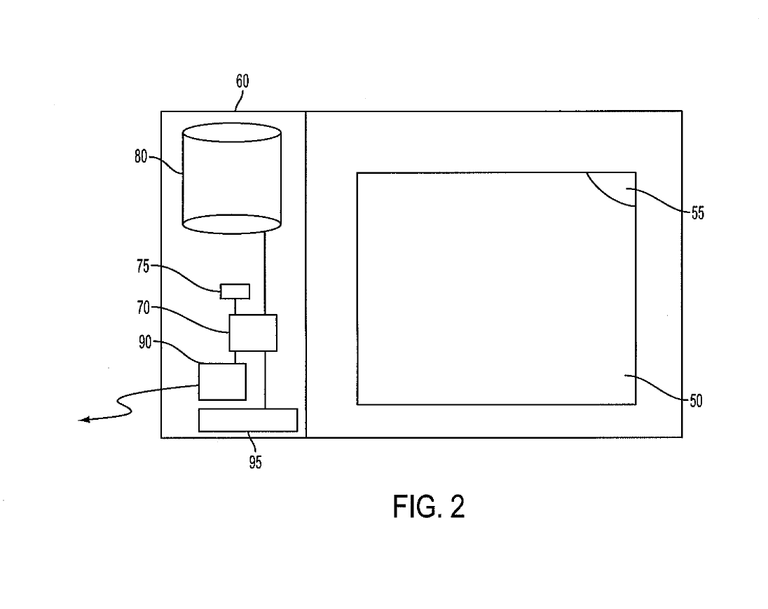

As shown in FIG. 2, the interior of the safe can be divided into space for physical storage for valuable documents and possessions 50, and space 60 for electronic components. The space 60 can include components for the storage of electronic media and other electronic data. In a preferred embodiment, the physical storage space comprises approximately 80% of the interior of the safe, whereas space for the electronic components comprises approximately 20% of the interior of the space. The interior storage space may also include a camera 55 to monitor the inside of the safe.

In one embodiment of the invention, the interior space includes a processor 70 and memory 75, capable of being programmed to interact with an internal storage device 80 and a communications interface 90. A power supply 95 powers the electronic components. As discussed below, the device can be connected to a wired or wireless network, and can be accessed through a PC, a wireless device, or via the Internet, using secure communications protocols employing IP (internet protocol), Wi-Fi, satellite, cellular and Ethernet technologies. Programming to operate the device, and to obtain and manage the digital information stored therein, can be run within a processor located inside the device. In an alternative embodiment, the processing and programming are run on a standalone computer, or through a web-based service, in which case the safe would merely act as a network or Internet-connected storage or back-up storage device. In a third alternative embodiment, certain aspects of the system are run on a standalone computer or mobile device, while other aspects are run within the device.

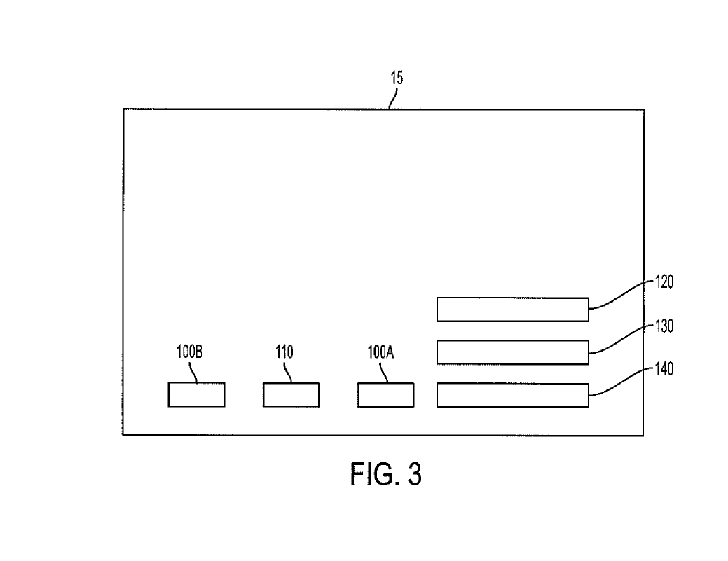

The apparatus may also include other hardware. For example, FIG. 3 shows the rear side of the housing 15 according to one embodiment, which includes one or more USB ports 100A and 100B, an Ethernet connection 110, and multiple bays for removable storage devices 120, 130, 140. Thus, the invention can be programmed for wireless or wired communications, and for printing. It can also employ multiple types of storage devices, including a combination of permanent and removable storage devices. Although the ports in FIG. 3 are shown on the rear side of the safe, they may be arranged on any surface that may be assessed by the user, including the interior of the safe accessed via the door.

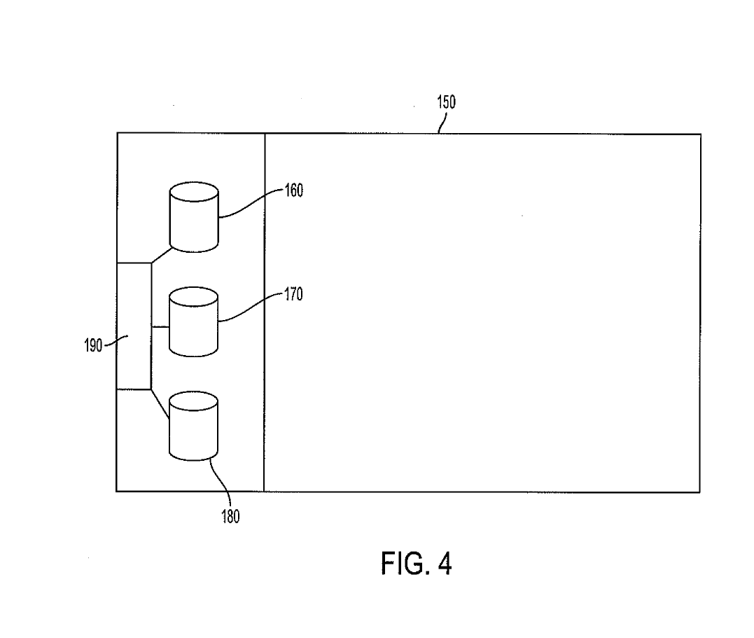

The embodiment shown in FIG. 4 is directed to a safe that acts as a stand-alone storage device. In this embodiment, housing 150 includes one or more electronic storage devices 160, 170, 180. The storage devices may be permanent, removable, or portable, or a combination thereof. Such devices include hard drives, memory sticks, thumb drives, optical drives, magnetic tape, solid states drives and the like, or combinations thereof. Multiple devices can be employed to increase the storage capacity of the device, or to provide redundancy to reduce the risk of data loss. In one embodiment, the device can include a permanent storage device operating in a redundant fashion with a removable device.

The memory devices are accessible via one or more communication ports on the exterior of the apparatus, or via wireless networking technology. In either configuration, the apparatus includes components 190 that provide the communications capability.

The system of FIGS. 1-3 can also include GPS technology so that the location of the safe can be detected or monitored.

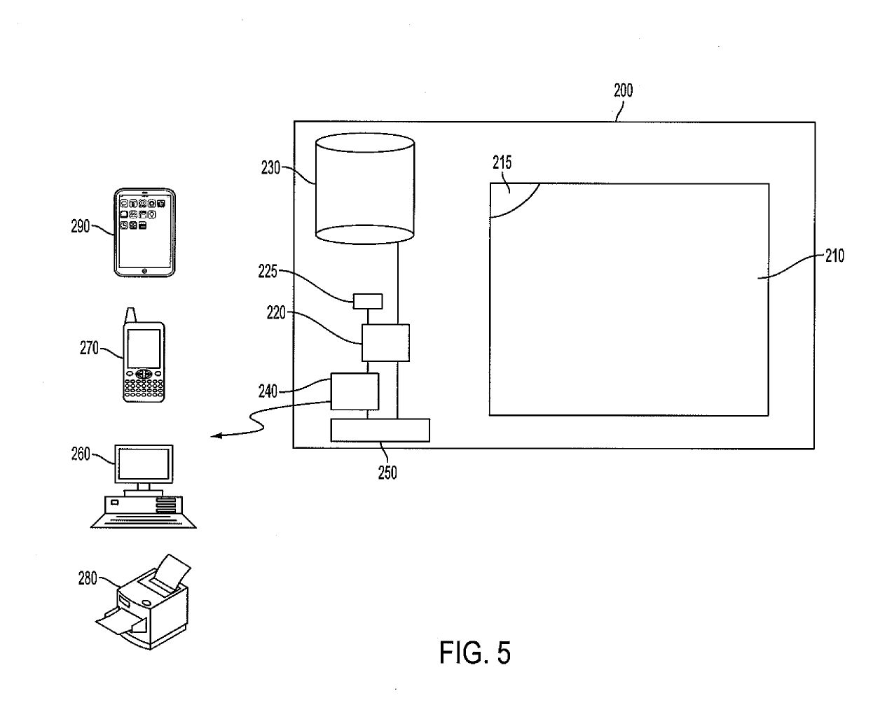

The embodiment of FIG. 5 includes processing capability provided by a CPU 220, interacting with memory 225, to store and access information in a storage device 230 in accordance with programming options selected by the user. In this embodiment, the housing 200 includes interior space 210 for storage of important physical items, and a camera 215 for monitoring the interior space.

The system and apparatus of FIG. 5 can be connected to one or more computers 260, or peripherals such as a printer 280, through communications device 240, which is powered via power supply 250. The system and apparatus can also communicate with mobile devices, such as a mobile phone or a tablet computer 270 via the communication device 240, and with Internet-enabled consumer electronics products 290.

The systems and apparatus depicted in FIGS. 4 and 5 can act as a direct-attached or direct-wireless storage device, in communication with a personal computer or a mobile computing device. The systems and apparatus depicted in FIGS. 4 and 5 can also act as a network-attached or network-wireless storage device, or as a media server, which would be accessed through a local area network, a wide area network, or over the Internet. Further, the system and apparatus of these figures could be operated as part of a storage area network, for example when employed in the context of a service provided by business or commercial entity.

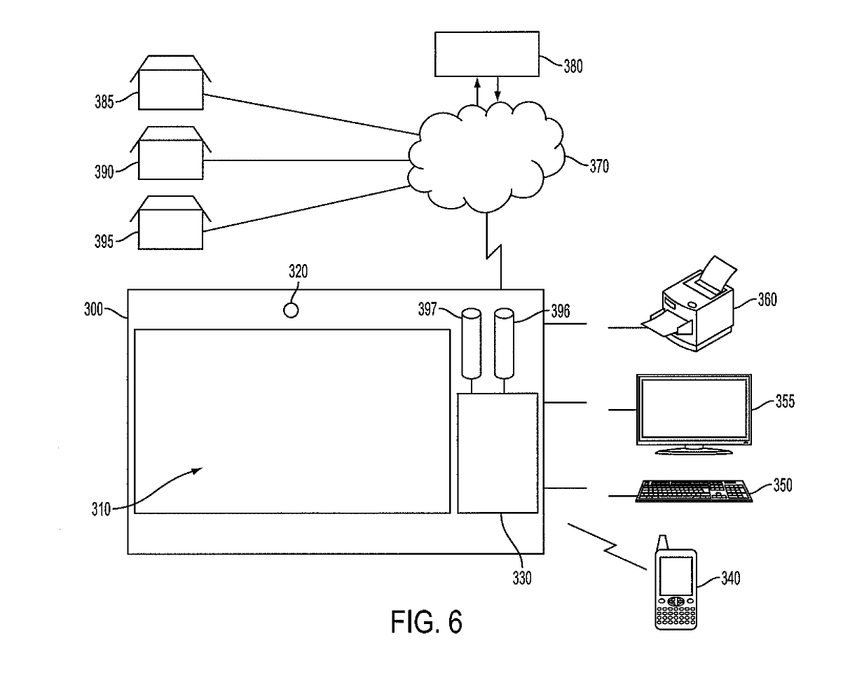

The system and apparatus may also be programmed to connect to external services via the Internet, as depicted in FIG. 6. This embodiment includes processing capability provided via processor 330, which can be accessed via a mobile device 340 or via peripherals 350, 355 and 360 attached via wired or wireless technology. Internet connectivity 370 enables the device to connect to a service 380 such that the user can update the operating system of the apparatus, and related software such as the user interface, described below. The connectivity also enables the user to select the desired configuration programming and functionality remotely, including via the Internet. Programming enables the device to connect to one or more financial institutions 385 to periodically access and download financial data, such as mortgage, credit card, banking or other financial asset information. The user can also enable programming that permits the apparatus to periodically access credit databases or credit monitoring services 390 such as those offered by Equifix, Experian and TransUnion. The apparatus can also connect to ID theft monitoring services 395 such as Lifelock and Identity. In accordance with the programming selected by the user, the device would thereafter periodically download the relevant information via the Internet or satellite based communications and store it in the storage devices 396, 398 to provide a convenient way to track, store and monitor such information.

The system and apparatus of FIG. 6 also includes an external camera 320, which may record photographs or video whenever the device is accessed. Files associated with the camera can be stored within the device, or transmitted to a mobile device or another computer. This embodiment also includes interior space 310 for storage of physical items, although the interior space is optional.

Advanced monitoring functionality can also be provided by the system and apparatus shown in FIG. 6. For example, the system and apparatus can include GPS technology to monitor the location of the safe. The system and apparatus can generate and transmit alerts when the safe is moved or accessed, or when programming errors occur, such as the inability to connect to a selected outside service. The system and apparatus can also send an alert when connected outside services 385, 390, 395 detect abnormalities or other trigger events. The foregoing alerts can be transmitted to the user, or a recipient designated by the user, via email or text message or video message. Alerts could also be transmitted to an external monitoring service, to governmental authorities, or to credit reporting and/or id theft services.

The embodiment of FIG. 6 can provide built-in secure, back-up storage for designated digital content residing in a computer, phone, handheld or mobile device, consumer electronic device and online website or online storage site. The data can also be encrypted. The system can also store photographs of non-digital valuables stored in the safe. Further, data collected, stored or backed-up in the device can be further backed up via the Internet connection to an Internet-based secure storage service.

In this embodiment, data can be securely uploaded, modified, backed up, deleted, accessed, shared and downloaded using a software application running on a computer, phone, mobile device or an Internet-enabled product. Thus, a user can access the device from a large number of clients across a variety of desktop and mobile operating systems. This open configuration also permits private and public file sharing of stored digital data which would be useful for background and employment evaluations, meetings with accountants, lawyers and financial planners, and applications for credit.

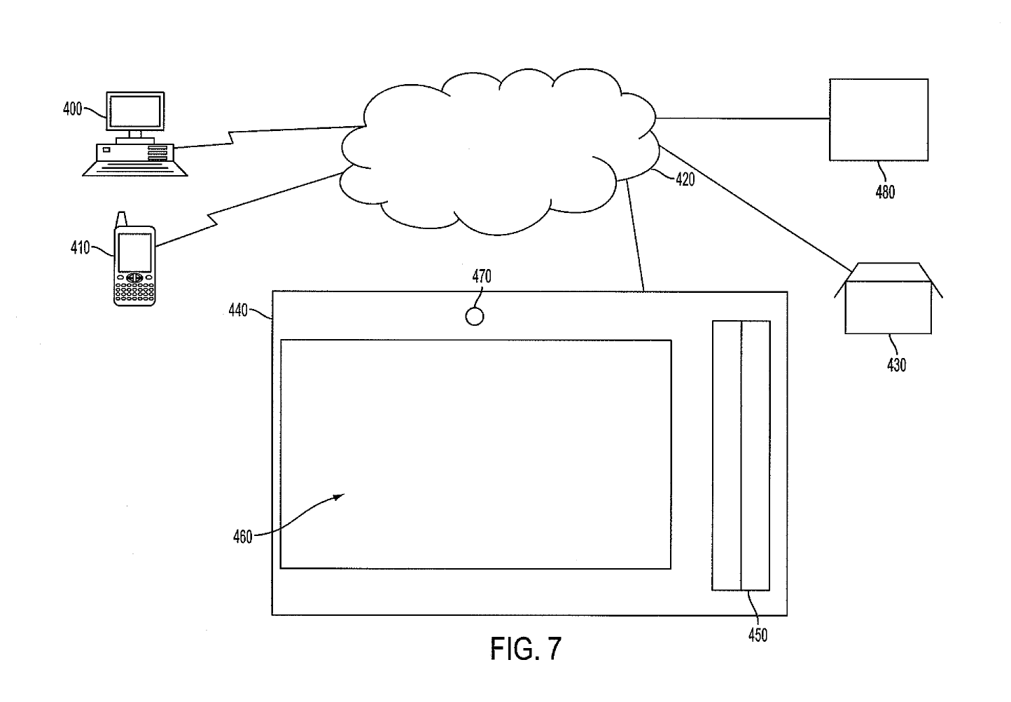

A cloud-based embodiment of the invention is depicted in FIG. 7. In this embodiment, the system is accessed and programmed via a PC 400 or mobile computing device 410 connected to the Internet 420. Based upon the selected programming, the application, running on the PC or mobile device, connects to one or more services or institutions 430 to obtain preselected data for collection and review, and for storage within devices 450 within the secure safe 440. The safe may also contain physical storage space 460 and one or more cameras 470. To further protect the data from loss or destruction, the system can be programmed to back-up the stored data to an external location 480 via the Internet 420. The safe 440 connects to the Internet via wired or wireless technology or satellite based technology.

FIG. 7 also depicts an embodiment wherein the application is run via a service operating within the cloud. In this embodiment, the user can access the service via an Internet connected PC or mobile device 400, 410 to select the desired configuration and programming. The cloud-based service will thereafter access the desired services and on-line resources, including financial institutions, monitoring services and social media services to obtain the preselected information, and will send the information to be stored to a device designated by the user. In such case, the secure storage device could be located in a home or at another secure location. The system can also be programmed to automatically store or back-up the stored information to an alternative storage device 480 or cloud-based storage service on a regular or periodic basis.

For both embodiments, the user can access the stored information via an Internet connected PC or mobile device, and view the information via a user interface.

In the event of a security breach, or if credit data or personal identification are at risk, the cloud based service can, as programmed by the user, automatically erase all digital data and send text, voice or video messages to the user, law enforcement authorities, financial institutions, credit monitoring agencies or persons or institutions designated by the user. GPS technology may also be employed to monitor the location of the safe.

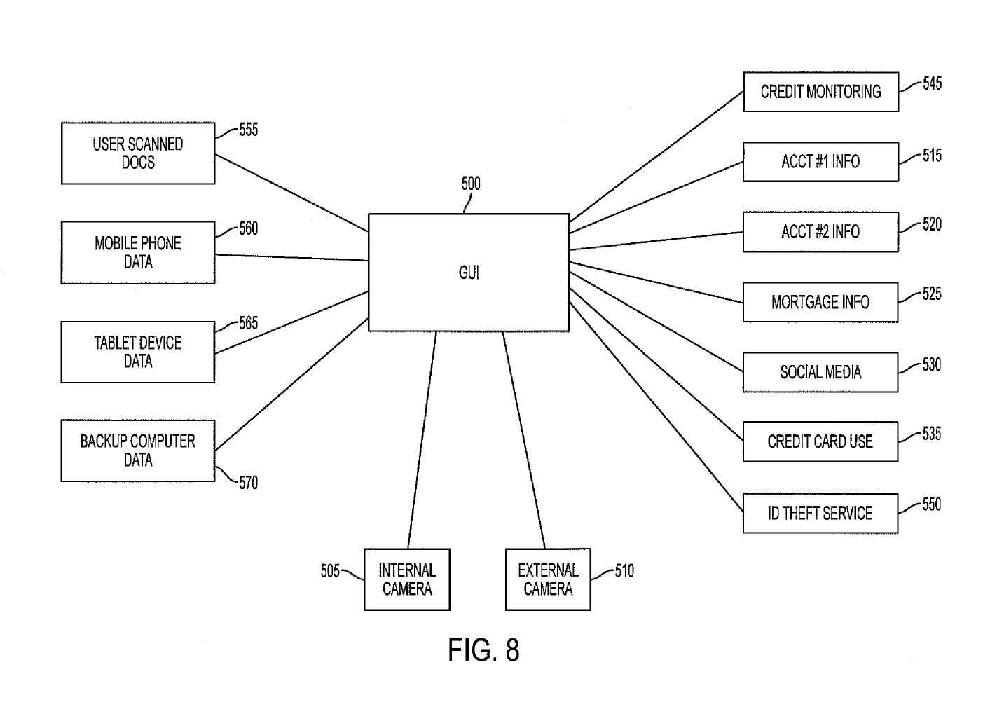

As shown in FIG. 8, the invention further includes a graphical user interface or dashboard to provide a consolidated view of the apparatus and the items stored therein via the internal and external cameras 505, 510. The interface provides an inventory of stored electronic data via, for example, a file list. The user interface further provides summaries of monitored/accessed web sites and services, such as financial institutions 515, 520, 525, credit card companies 535, credit bureaus 545, identity theft monitoring services 550 and social media providers 530. It can further include a history list showing the date and time that information was obtained from each external source, and the most recent back-up of data. Additional information accessible through the dashboard includes a list of electronic data and files copied or backed-up from computers and mobile devices 560, 565, 570 synched to the system, and documents scanned for storage and safekeeping 555. A summary of the owner's identify profile based on internet monitoring services can also be provided. The dashboard can be run on a PC or mobile device through a software application, or accessed via the web directly from the cloud-based service.

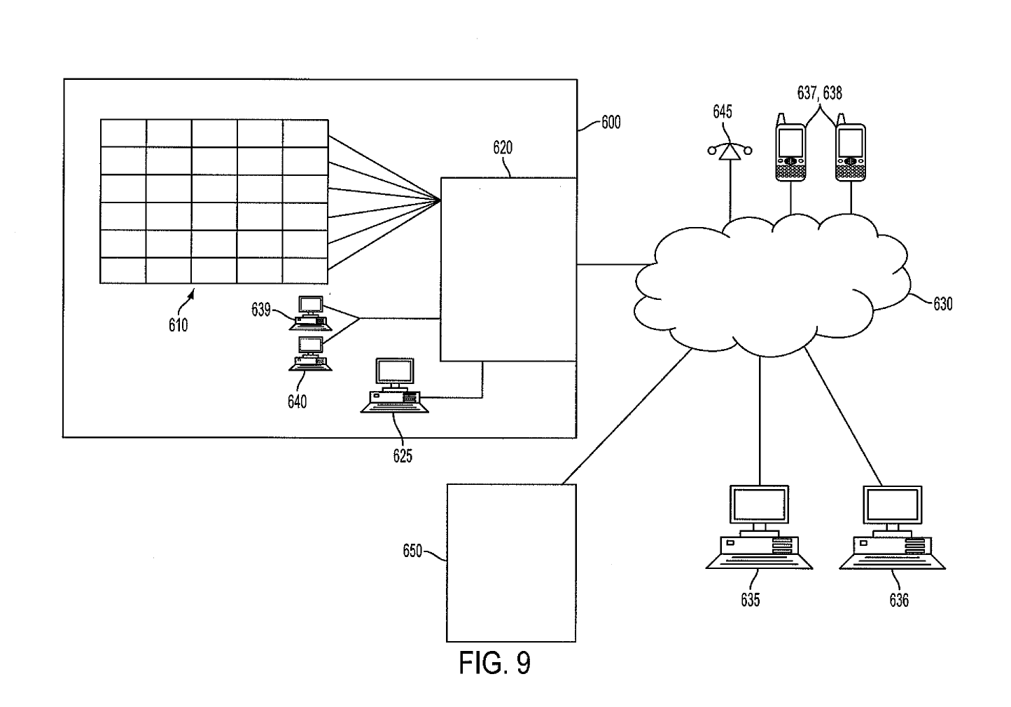

As shown in FIG. 9, the invention may also be implemented on a commercial scale, where information is stored for a plurality of users in one common, secure location 600. Here, a plurality of “safes” 610 may be connected to a server 620. The server can be connected to the Internet 630 for access by multiple remote clients such as PCs 635, 636 and mobile computing devices 637, 638. The server can be accessed via local clients 639, 640 connected to the Internet via wired and wireless connections. In such a configuration, a user may program the system, upload information for storage, and access stored information via a variety of platforms. As in other embodiments, the system has the ability to access or receive external information from a variety of sources and services 650. Further, the system includes an administrator 625 linked to the server that enables the institution to set up and maintain accounts, controls and access privileges. Another feature of this embodiment is access via a standard telephone 645, where certain account information could be provided through a voice activated, automated attendant system.

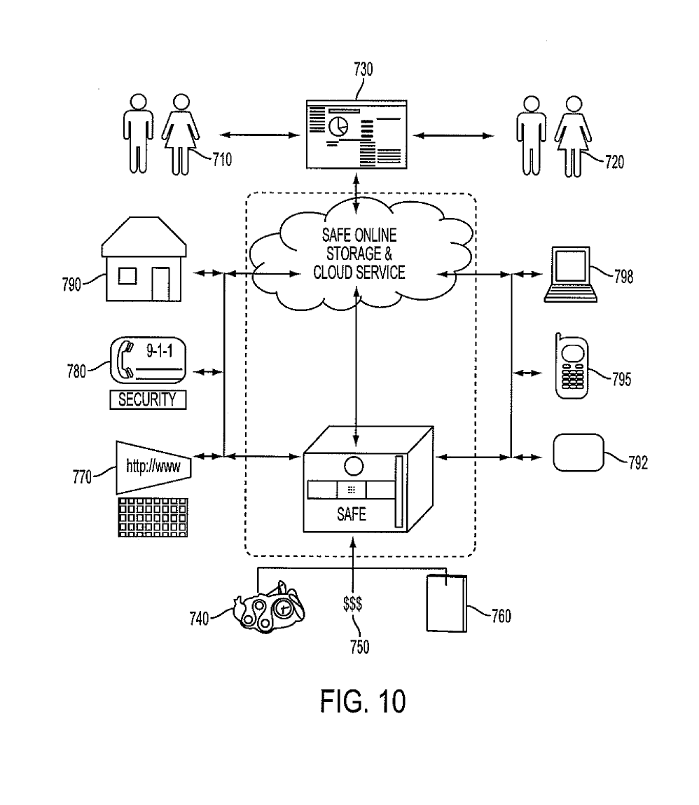

Both the physical safe and its storage and cloud service may be connected to personal electronic devices, such as laptop 798, phone 795, or tablet 792, as shown in FIG. 10. In this embodiment, the user can upload data directly to the safe or the online storage or the cloud service. Valuables such as jewelry 740, cash 750, or passports 760, may be stored in the safe.

Both the physical safe and its storage and cloud service may also be connected to financial service providers 790, such as banks, financial institutions, or credit monitoring services, and interact with these entities and services to synchronize, monitor and report information. Both the physical safe and its storage and cloud service may be connected to an authorized online website or application 770, which may be used to synchronize, monitor or report information, and also monitor the safe owner's identity for new credit and non-credit applications, address changes, and any criminal websites for illegal disclosure or use of the owner's information. Both the physical safe and its storage and cloud service may also connect to designated security services 780. The physical safe and its storage and cloud service may be programmed to send security alerts and other forms of security notification to the user, or to individuals, authorities and institutions designated by the user, if certain events are detected by the system or by monitoring services that are synched to the system. The dashboard 730 permits owners 710, and/or those with authorized access 720, to access the information contained both within the safe and online on the safe's storage and cloud service.

Each of the foregoing embodiments can include a variety of security features. For example, when the system is compromised, it can automatically sound an alarm and send text, voice or video messages or alerts to the owner or another designated person. Law enforcement authorities, financial institutions and credit monitoring agencies could also be informed. For added security, the device could be programmed by the user to automatically erase all or a portion of the digital data, or the back-up data, in conjunction with text and voice alerts. Where an internet-connected physical device is utilized, it can be programmed so that it is disabled, locked or unlocked via an Internet or satellite connection by an online computer, tablet, phone, handheld Internet device or internetworked product.

The internal and/or external cameras can also be programmed to be activated by a software application, computer, phone, handheld, mobile device or any product connected to the Internet to monitor and report activities in and around the apparatus. In addition, the camera can be programmed to activate whenever the apparatus is opened, moved, or tampered with, in order to record and upload recorded images and video to a web-based storage hosting service in the cloud.

The alert feature of the invention can be programmed a variety of ways. For example, the system and apparatus can be programmed to provide alerts via email, voicemail, text message, etc. In addition to security breaches, alerts could be sent by changes in a credit score or when a possible identity theft is detected. In addition, an alert can be sent when the system programming is not properly executed, such as the failure to execute a backup operation. Alerts and monitoring could also be received or performed via a security monitoring service.

The alternative configurations and steps described above are purely illustrative in nature, and can be performed in any order, in parallel, in whole or in part, unless indicated by the present disclosure, without departing from the spirit, scope, or essential characteristics of the invention. The foregoing embodiments are each therefore to be considered in all respects illustrative, rather than limiting the invention. Thus, the present invention is only limited by the claims which follow.

What is claimed is:

1. An internetworked safe comprising:
a housing having an interior compartment for storage of physical items;
an outer door having a locking mechanism to control access to the interior compartment;
an electronic data storage device arranged within the housing;
a computing device, capable of connecting to the internet and having an associated display means, programmed to connect to data sources, download data from such sources, and transmit such data for storage in the internetworked safe;
communications means to permit communication between the computing device and the electronic data storage device, such that data obtained by said computing device from internet data sources can be transmitted to and from said electronic data storage device within said internetworked safe; and
a graphic user interface, generated by said computing device for viewing via the display, that enables a user to identify and organize data obtained and stored in the electronic data storage device.

2. An internetworked safe as described in claim 1 wherein the computing device is further programmed to copy data stored in the electronic data storage device to an internet-based storage service.

3. An internetworked safe as described in claim 1 wherein said electronic data storage device is removable from the housing.

4. An internetworked safe as described in claim 1 wherein said electronic data storage device comprises two different storage devices operating to provide redundant storage, wherein one of the storage devices is removable from the housing.

5. An internetworked safe as described in claim 1 wherein said communications means includes a USB port and an Ethernet port for wired connections.

6. An internetworked safe as described in claim 1 wherein said communications means includes wireless communication capabilities.

7. An internetworked safe as described in claim 1 wherein said computing device comprises one or more of a computer, mobile phone, tablet device, consumer electronic device, or online service.

8. An internetworked safe as described in claim 7 wherein said computing device is a smartphone.

9. An internetworked safe as described in claim 7 wherein said computing device connects to internet based data sources via satellite technology.

10. An internetworked safe as described in claim 1 wherein said internet data sources comprise one or more cloud-based services providing financial data, credit monitoring, or identity theft monitoring.

11. An internetworked safe as described in claim 1 wherein said data sources comprise one or more social media platforms.

12. A system for secure storage and monitoring of personal digital information comprising:
a cloud-based service accessible by a user for obtaining personal data and information from a variety of data sources;
downloading means for downloading accessed personal data and information from the cloud-based service for secure storage;
a storage device comprising an internetworked safe including means for storage of electronic data;
communication means permitting said internetworked safe to receive the data and information downloaded from the cloud-based service;
a monitoring system for monitoring accessed data to detect changes therein and compare such changes to thresholds set by the user;
an alert generator configured to transmit one or more electronic alerts when said monitoring system detects changes that exceed user thresholds; and
system control means enabling said user to access the cloud-based service, program settings for downloading of personal information, enable storage of downloaded electronic data and information to the storage device, control access to the internetworked safe and information and data downloaded and stored therein, and configure the monitoring system and alert generator.

13. The system as described in claim 12 further comprising online data storage accessible and programmable by the system control means to permit back-up storage of data stored in the internetworked safe.

14. The system as described in claim 12 wherein said cloud-based service automatically obtains requested data from designated sources of information on a programmed, periodic basis, downloads such data to said storage device, and monitors such data according to the thresholds set by the user.

15. The system as described in claim 14 wherein the monitored sources of information include at least one of a user's financial information obtained from one or more financial institutions, credit information obtained from a credit agency, and information obtained from an identify-theft monitoring service.

16. The system as described in claim 15 wherein said alert generator is activated and an alert generated upon detection of events occurring in the monitored services in accordance with settings provided by the user.

17. The system as described in claim 16 wherein the alert notification process comprises one or more text messages transmitted to the user.

18. The system as described in claim 16 wherein the alert notification process comprises an electronic message sent to a monitoring service.

19. The system as described in claim 12 further comprising a camera positioned to capture images of said internetworked safe and configured to be activated when said safe is open or tampered with.

20. The system as described in claim 19, wherein when said camera is activated, the system transmits an alert comprising video or still images captured via said camera to said user or a monitoring service.

21. The system as described in claim 12 further comprising GPS technology to monitor the location of the storage device, wherein the alert generator is configured to transmit an electronic alert when the location of the safe changes.
